(19) United States
(12) Patent Application Publication
(10) Pub. No.: US 2006/0102500 A1
(43) Pub. Date: May 18, 2006

(54) Disc cover

(76) Inventor: Marlon Hertzog, Alexandria, LA (US)

Correspondence Address: MARLON HERTZOG, P.O. Box 8431, Alexandria, LA, 71306, US

(21) Appl. No.: 11/000,543

(22) Filed: Nov. 17, 2004

(51) Int. Cl. B65D 85/30; G11B 3/70

(52) U.S. Cl. 206/308.1; 369/291.1

(57) ABSTRACT

The scratchless CD/DVD cover is a permanent cover that encloses a single or dual sided CD (compact disc), DVD (digital video disc) or mini-disc. The hard plastic cover is dimensioned and configured to house a disc preventing the disc from being scratched or damaged from normal wear and tear. The cover is a permanent cover and eliminates the need to replace a CD/DVD by protecting it from scratches and harm while not interfering with the operation of the CD/DVD. The discs contain sound, data, or images in a digital format and are double or single sided.

### FIELD OF THE INVENTION

The invention relates generally to CD/DVD covers. More specifically, the invention relates to a permanent cover that completely encases a disc to prevent the disc from becoming scratched or damaged due to normal wear and tear.

### BACKGROUND OF THE INVENTION

CDs (compact discs) and DVDs (digital video discs) have long been the medium of choice for many avid music and movie lovers. CD quality sound and DVD quality movies have replaced the traditional audio cassette and VHS video tape as consumer favorites. When CDs and DVDs first came out, it was generally believed that you could handle them and not worry about damaging the discs or hindering the quality of the sound or picture. However, it soon became clear that if not handled with care, the CDs or DVDs could develop scratches which could make them unplayable. It is now known that CDs and DVDs can be quite fragile. If they are stepped or sat upon they can crack or break, rendering them useless. The mere dropping of one on the floor can produce a scratch that makes part or all of the disc unusable. When a disc is damaged the only recourse is to replace that disc. This not only is expensive, but sometimes the data, music or movie on the disc is in fact irreplaceable.

A solution to the problem of easily damaged CDs and DVDs is to place the discs in a permanent cover. The CD/DVD cover is a simple and effective product designed as a permanent cover for CDs, DVDs or mini-discs. The cover prevents the discs contained therein from scratches or other types of damage due to normal usage, handling and storage. The cover does not interfere with the operation of the CD, DVD, CDROM or mini-disc.

### SUMMARY OF THE INVENTION

The scratchless CD/DVD cover is a permanent cover for a single or double sided CD, DVD or mini-disc that protects the disc from scratches or other types of damage due to normal ware and tear. The disc is housed completely within the cover such that during non-use, the persons handling the cover have no contact with the actual CD or DVD. When in use, that is, when inserted within a CD or DVD player equipped to handle the scratchless cover, a window located on the cover is opened allowing the CD or DVD reader to read the data on the disc. The cover has a semi-circular version with a stop tab that prevents the cover from rotating while in use. A square version by virtue of its shape prevents the cover from rotating while in use. The cover also includes a spring-loaded site window cover that protects the CD or DVD during handling or storage. The site window allows the reading device (i.e., a laser) to retrieve or store data, music or video from or to a CD or DVD. The hard plastic material that makes up the cover can be made in any color with graphics and labeling affixed to the cover.

Accordingly, it is a principal object of the invention to provide a CD/DVD cover that completely encases the disc.

It is another object of the invention to provide a CD/DVD cover that prevents the encased disc to be damaged by scratches or other types of wear and tear.

It is a further object of the invention to provide a CD/DVD cover that has a site window which allows access to the disc by the disc reader.

Still another object of the invention is to provide a CD/DVD cover that encases a dual sided disc.

These and other objects of the present invention will become readily apparent upon further review of the following specification and drawings.

### BRIEF DESCRIPTION OF THE DRAWINGS

FIG. 1 is the outer view of the rectangular permanent CD/DVD cover.

FIG. 2 is the inner view of the bottom cover.

FIG. 3 is the inner view of the top cover.

FIG. 4A shows the site window cover.

FIG. 4B shows the side view of the site window cover.

FIG. 5 is the bottom outside view of the circular permanent CD/DVD cover.

FIG. 6 is the inner view of the bottom cover.

FIG. 7 is the inner view of the top cover.

FIG. 8A shows a side view of the site window cover.

FIG. 8B shows the bottom view of the site window cover.

### DETAILED DESCRIPTION OF THE PREFERRED EMBODIMENTS

The scratchless CD/DVD cover is a permanent cover that encloses a CD (compact disc), a DVD (digital video disc) or a mini-disc. The hard plastic cover is dimensioned and configured to house a disc preventing the disc from being scratched or damaged from normal wear and tear. The cover is a permanent cover and eliminates the need to replace a CD/DVD by protecting it from scratches and harm while not interfering with the operation of the CD/DVD. The discs contain sound, data, or images in a digital format and are double or single sided.

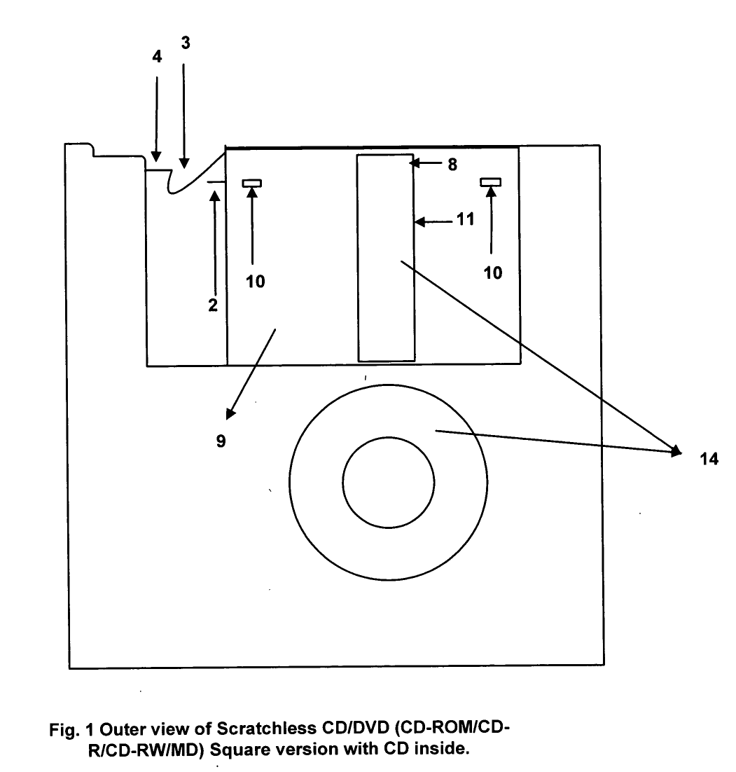

Turning now to FIG. 1 of the drawings, the scratchless CD/DVD cover 1 shows the disc 14 with a site window cover 9 in the open position. The contact initiating point 4 where the player site window opening device contacts the site window and forces it open. This device then maintains the site window open when it reaches the locking point 3 and allows the reading device (laser) to read data from the disc 14 via the site window 8 which is aligned with the site window for the site window cover 11. The guide groove 2 allows the site window cover 9 to move back and forward straight and true due to the guide tabs 10 that are punched from the metal site window cover 9 to create metal prongs to follow the guide groove 2.

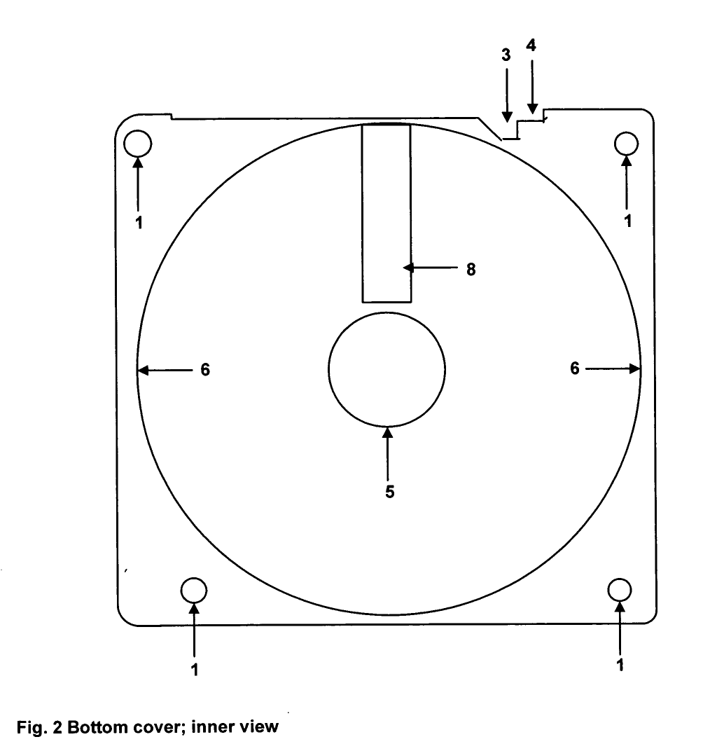

FIG. 2 shows the inner side of the bottom cover in which the mounting points 1 fit into the mounting points of the other side. The disc guide lip 6 allows the disc to rotate within the cover without restricting rotation but doesn't allow the disc to misalign itself. The rotation access hole 5 is larger than a disc hole as to not interfere with the player rotation axle. The rotation access hole 5 has a lip so that the disc 14 contained within does not contact the cover 1. The site window 8 allows the reader (laser) to interface with the disc. Also the contact initiating point 4 and locking point 3 allow site window cover to be opened.

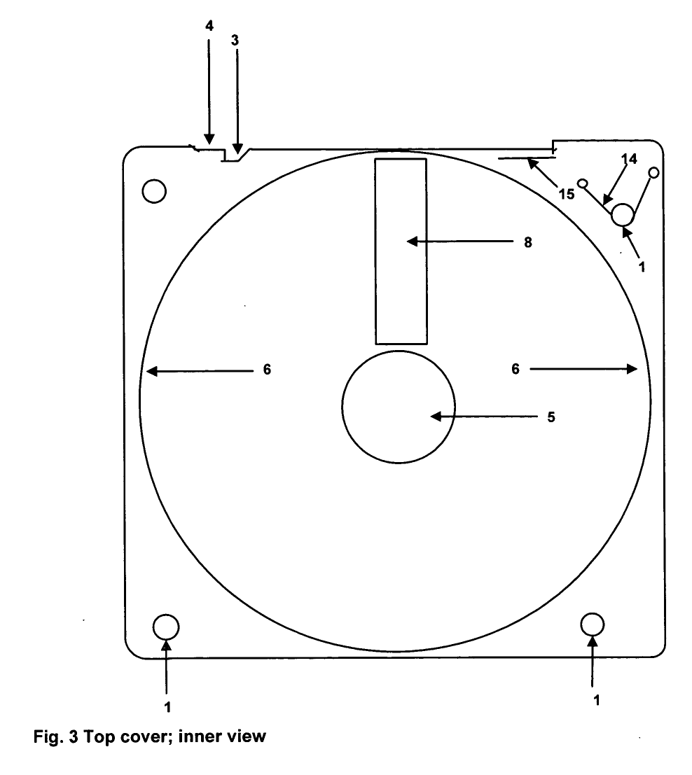

FIG. 3 shows the inner side of the top cover to be joined to the bottom cover via mounting points 1. The site window cover spring 14 is held in place by the mounting points 1 and keeps the window closed when the reader is not manipulating the disc. The guide groove 15 guides the site window cover and holds it in place. The disc guide lip 6 allows the disc to rotate within the cover without restricting rotation but doesn't allow the disc to misalign itself. The rotation access hole 5 is larger than a disc hole as to not interface with the player rotation axle and also has a lip to prevent the disc from contacting the cover. The site window 8 allows the reader (laser) to interfere with the disc. The contact initiating point 4 and locking point 3 allow the site window cover to be opened.

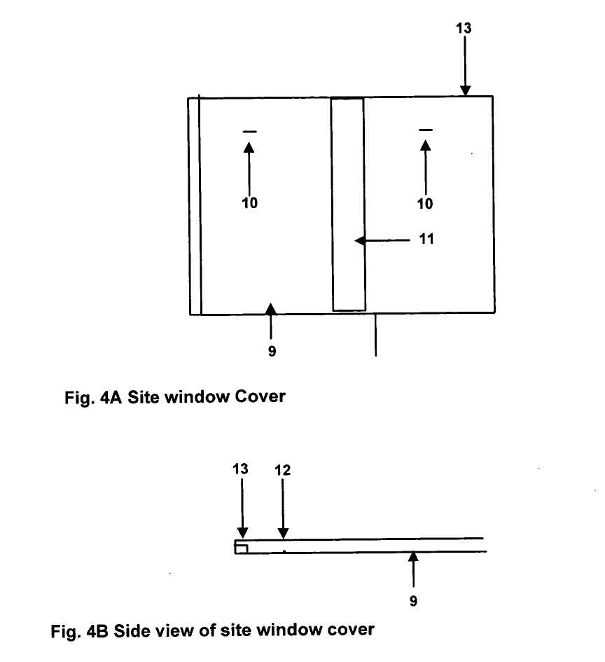

FIG. 4A shows the site window cover 9 itself and the site window cover site window 11. The site window cover spring attachment point and guide 13 is an attachment point protruding into the disc cover for the spring force displacement point and also attaches to a groove inside the disk top cover inner side shown by FIG. 3, to guide the site window cover 9. The guide tabs for the site window 10 guides the window and holds it on the cover.

FIG. 4B shows a side view of the site window cover 9 and the L shaped site window cover spring attachment point and guide 13. It also illustrates the prongs created by the punched out guide tabs 10.

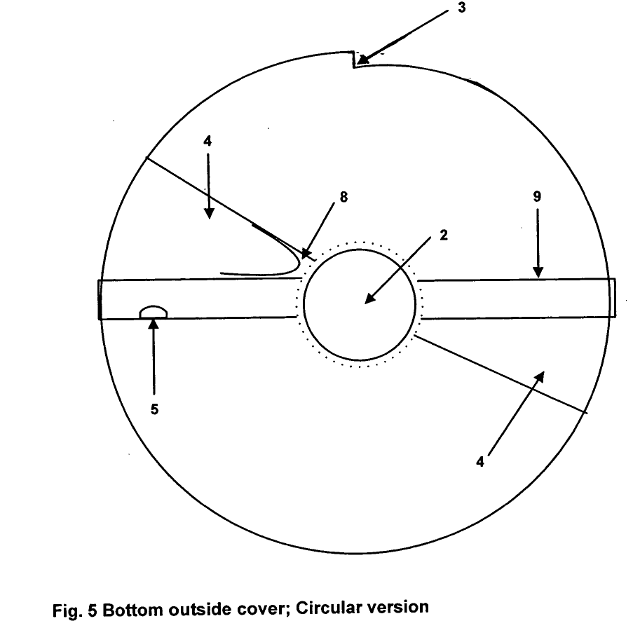

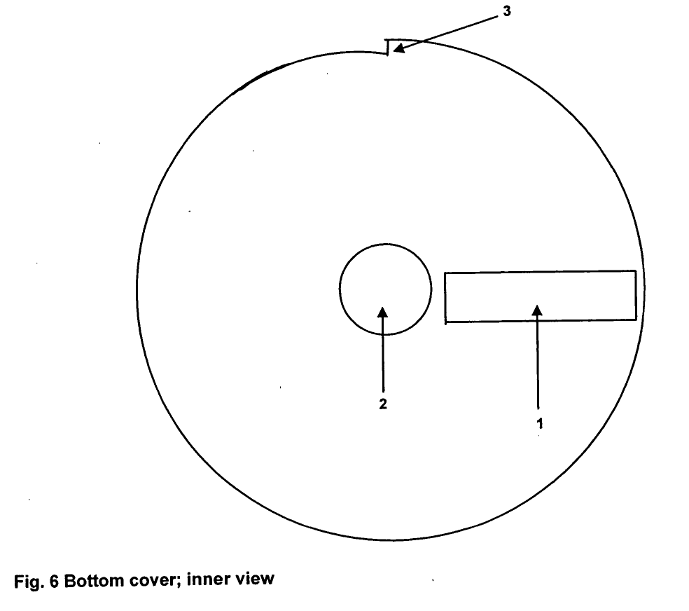

FIG. 5 shows a circular version of the scratchless optical device cover which utilizes a stop tab 3 so that the cover does not rotate while the optical device disc inside does. The rotation axle access hole 2 is shown which is larger than the actual disc hole in order not to interfere with the rotation axle of the player. The site window cover 9 conceals the site window (FIG. 6) while in the closed position. The site window cover spring 8 provides the tension necessary to keep the site window 9 in the closed position while the disc is not in use. The anointed area 4 limits the movement of the site window cover 9 and provides a tension force support for the spring 8. The site window cover contact initiating point 5 is a raised tab on the site window cover 9 to allow the player a contact area for opening the site window cover 9.

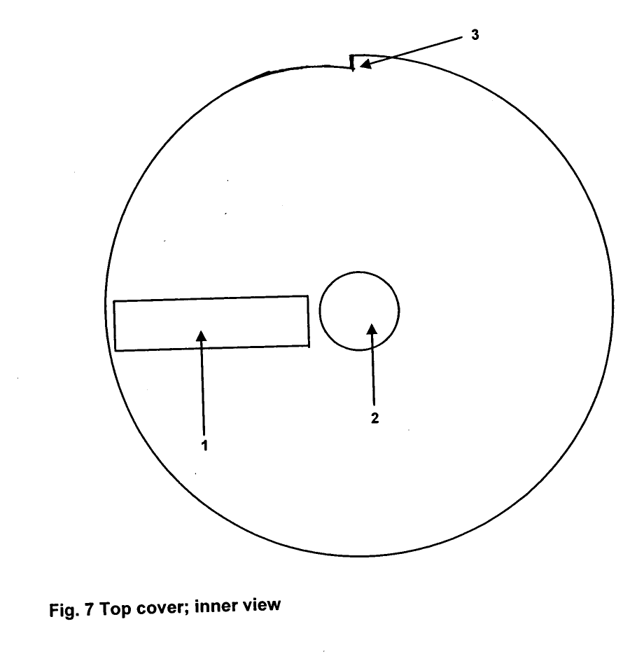

FIG. 6 illustrates the bottom inner cover with a stop tab 3 necessary to stop cover rotation, rotation axle access hole 2 and the site window 1 that allows the player to manipulate the disc inside. FIG. 7 illustrates the top inner cover with stop tab 3 necessary to stop cover rotation, rotation axle access hole 2, and the site window 1 that allows the player to manipulate the disc inside.

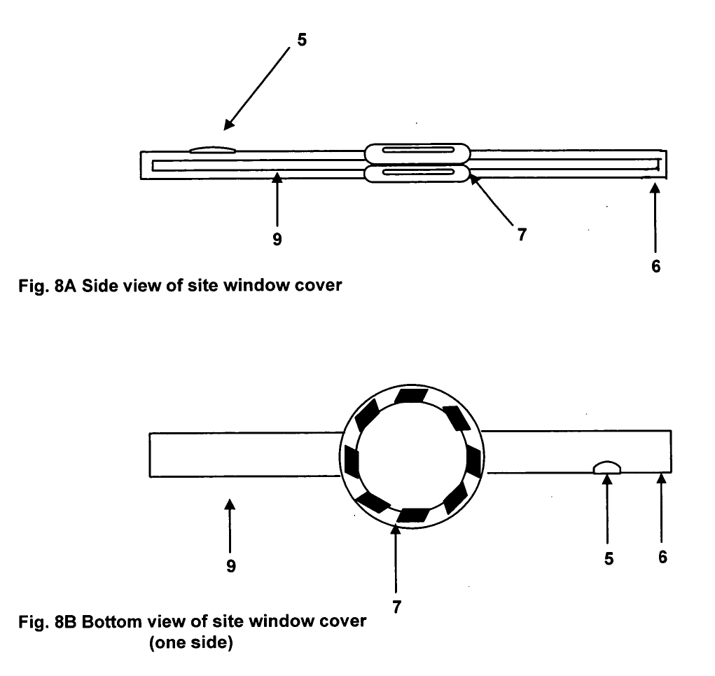

FIG. 8A illustrates a side view of the site window cover 9 with the site window cover contact initiating point 5. The site window cover 9 actually encompasses the sides of the optical disc cover to increase stability. The site window cover positioning tabs 7 protrude through the rotation axle access hole FIG. 7, 2 and stabilize the site window cover 9 and also creates a pivoting point. The positioning tabs 7 also prevents the disc contained within from contacting the cover 1.

FIG. 8B illustrates a bottom view of the site window cover 9 with the site window cover contact initiating point 5. The site window cover 9 actually encompasses the sides of the optical disc cover 6 to increase stability. The site window cover positioning tabs 7 protrude through the rotation axle access hole FIG. 7, 2 and stabilize the site window cover 9 and also creates a pivoting point. The positioning tabs 7 also prevents the disc contained within from contacting the cover 1.

It is to be understood that the present invention is not limited to the sole embodiment described above, but encompasses any and all embodiments within the scope of the following claims.

We claim:

1. A cover for enclosing a disc comprising;
a first side,
a second side,
a site window on said first side and said second side,
attachment means for attaching said first side to said second side, and
means for opening said site window such that when said site window is opened access to the disc is possible.

2. The cover for enclosing a disc according to claim 1 further comprising a disc guide lip wherein the disc is allowed to rotate within the cover without becoming misaligned.

3. The cover for enclosing a disc according to claim 2 further comprising;
a disc having a disc hole, and a rotation access hole with a raised lip so said disc does not contact said cover wherein said access hole is larger than said disc hole.

4. The cover for enclosing a disc according to claim 3 wherein said means for opening said site window comprise a site window cover.

5. The cover for enclosing a disc according to claim 4 further comprising;
a contact initiating point,
a locking point,
a guide groove, and
a plurality of guide tabs.

6. The cover for enclosing a disc according to claim 5 wherein the guide groove allows the site window cover to move back and forward straight due to one of said plurality of guide tabs.

7. The cover for enclosing a disc according to claim 6 further comprising a site window cover spring that is held in place by a mounting point such that the site window cover is closed.

8. The cover for enclosing a disc according to claim 7 wherein the guide groove guides the site window cover and holds the site window cover in place.

9. The cover for enclosing a disc according to claim 8 wherein a contact initiating point and locking point allow the site window cover to be opened.
